(19) United States
(12) Patent Application Publication
(10) Pub. No.: US 2002/0159273 A1
(43) Pub. Date: Oct. 31, 2002

(54) Method and apparatus for headlamps

(75) Inventor: Jeffrey Allen Erion, Plymouth, MI (US)

Correspondence Address: BRINKS HOFER GILSON & LIONE, P.O. BOX 10395, CHICAGO, IL, 60610, US

(73) Assignee: VISTEON GLOBAL TECHNOLOGIES, INC.

(21) Appl. No.: 09/844,886

(22) Filed: Apr. 27, 2001

(51) Int. Cl. F21V 29/00

(52) U.S. Cl. 362/547; 362/294; 362/345

(57) ABSTRACT

A headlamp apparatus comprising a cup-shaped reflector comprising a front opening, a rear opening and a valve assembly disposed thereon for allowing air external to said headlamp apparatus to flow into an interior of said headlamp while moisture is prevented from entering into said interior of said headlamp apparatus, a lens secured to said front opening for closing said front opening and defining said interior and exterior of said headlamp apparatus and a socket retention assembly containing a light source disposed within said rear opening.

### BACKGROUND OF THE INVENTION

The present invention relates generally to headlight constructions, and more particularly to a headlight for automotive vehicles or the like.

### DISCUSSION OF RELATED ART

There are basically two different types of headlight constructions for automotive vehicles and similar applications. One of these is the “sealed-beam” type of headlight wherein the reflector and the filament are united in a unit which is discarded in toto when the filament or the envelope becomes damaged. Current sealed beam headlamps use glass for the lens and reflector and the two pieces are hermetically bonded in production. The bulb is also sealed within the lamp. In these sealed-beam headlights the interior of the construction is totally protected against any deleterious ambient influences until and unless the envelope should become damaged in some way. This is advantageous but it is also expensive when the entire unit must eventually be replaced. Furthermore, known sealed beam lamps rely on mechanical components for aiming the beam from the headlamp.

The other type of headlight construction is the more conventional one. It utilizes a cupped reflector, the open side of which is provided with an opening through which an incandescent bulb is inserted into the interior of the reflector. If damage results to the bulb for any reason, for instance if the filament burns out, the bulb is simply removed through the opening and replaced with a new one.

The present invention is concerned with the second type of headlight construction, that is the type utilizing a replaceable bulb as opposed to the sealed-beam type of unit.

### BRIEF SUMMARY OF THE INVENTION

One aspect of the present invention regards a headlamp having a cup-shaped reflector with a front opening, a rear opening and a valve assembly. The valve assembly is located on the reflector and allows air external to the headlamp to flow into the interior of the headlamp while moisture is prevented from entering into the interior of the headlamp. The headlamp further includes a lens and a socket retention assembly. The lens is secured to the front opening of the headlamp thereby defining an interior and exterior of the headlamp. The socket retention assembly contains a light source and is disposed within the rear opening of the headlamp.

Another aspect of the present invention regards a method of operating a headlamp apparatus by turning on a light source within the headlamp apparatus, allowing air to flow within an interior of the headlamp apparatus, and preventing moisture from entering the interior of the headlamp.

Each aspect of the present invention provides the advantages of a composite style headlamp with a removable light source made of break resistant high impact and high temperature plastic that incorporates all of the optics on the reflector. Further, the headlamp is water resistant. A vent is place on the lamp that allows air external to the headlamp to enter into the interior of the headlamp while preventing moisture from entering.

Additional aspects and advantages of the present invention will become apparent from the following description and the appended claims when considered with the accompanying drawing.

### BRIEF DESCRIPTION OF THE DRAWINGS

FIG. 1 a side cross-sectional view of an embodiment of a headlamp according to the present invention;

FIG. 2 is a front view of the headlamp of FIG. 1;

FIG. 3 is a top cross-sectional view of the headlamp FIG. 1; and

FIG. 4 is a plan view of the headlamp of FIG. 1.

### DETAILED DESCRIPTION OF THE INVENTION

Referring to FIG. 1, a composite styled headlamp 100 with a replaceable light source 102 according to the present invention is designed to replace a sealed beam headlamp. As explained previously, the current sealed beam lamps are made from glass which makes the lamp sensitive to in-use breakage. The headlamp 100 uses a high impact (polycarbonate) circular lens 103 that is 20 times more resistant to breakage, such as sold under the trade name “Lexan” by the General Electric Company and typically has a diameter of 7″. A reflector 104 of the headlamp 100 is designed from a high temperature plastic material and has a general shape of a parabolic. Moreover, the optics of the headlamp 100 are incorporated into the reflector 104 to form the shape of the beam emitted from the headlamp 100. There are no separate optics on the lens 103 at all. The headlamp 100 relies completely on visual/optical aiming. The beam pattern is formed by the headlamp 100 clearly defines a horizontal line so that aiming/adjustment of the headlamp 100 can be achieved by visual or optical methods. The replaceable light source 102 is used in the headlamp 100, such that, if there is a failure of the light source 102, only the light source 102 must be replaced. The replaceable light source 102 incorporates its own seal, such that, when it is installed, the complete headlamp 100 is resistant to having water enter into the interior of the headlamp 100. A “patch” type vent 105 is placed on the headlamp 100 that allows only air to pass through into the interior and not moisture. The vent 105 equalizes the pressure in the headlamp 100 with the outside and reduces the internal stresses in the headlamp 100. This headlamp 100 is intended to be an exact replacement for the sealed beam lamp describe previously, and uses the exact same hardware for installation.

FIG. 1 shows a cup-shaped reflector 104, which is typically made of a high temperature plastic material, has a front opening 106 and a rear opening 107. The front opening 106 has a grooved annular portion 108 in which a tongue portion 109 of lens 103 is inserted and secured, usually by being adhesively secured in place. The lens 103 is made of high impact polycarbonate material that is 20 times more resistant to breakage than glass.

A socket retention assembly 110 containing the light source 102 is disposed within the rear opening 107 of the reflector 104, such that, terminals 111 of the socket retention assembly 110 extend rearward and outside of the reflector 104. An annular retainer ring 112 encircles the rear portion of socket retention assembly 110 when it is disposed within the rear opening 107 of reflector 104 for holding and sealing the socket retention assembly 110 within the rear opening 107 of the reflector 104. The use of the annular retainer ring 112 is known in the art and needs no further discussion here. The light source 102, typically a bulb, has a filament within it and has connecting portions for electrically connecting the light source 102 to the terminals 111 when the light source 102 is disposed within the socket retention assembly 110. The light source 102 is sealed within the socket retention assembly 110 by use of an O-ring (not shown) between the socket retention assembly 110 and the light source 102. Thus, the light source 102 is located in the interior of the reflector 104.

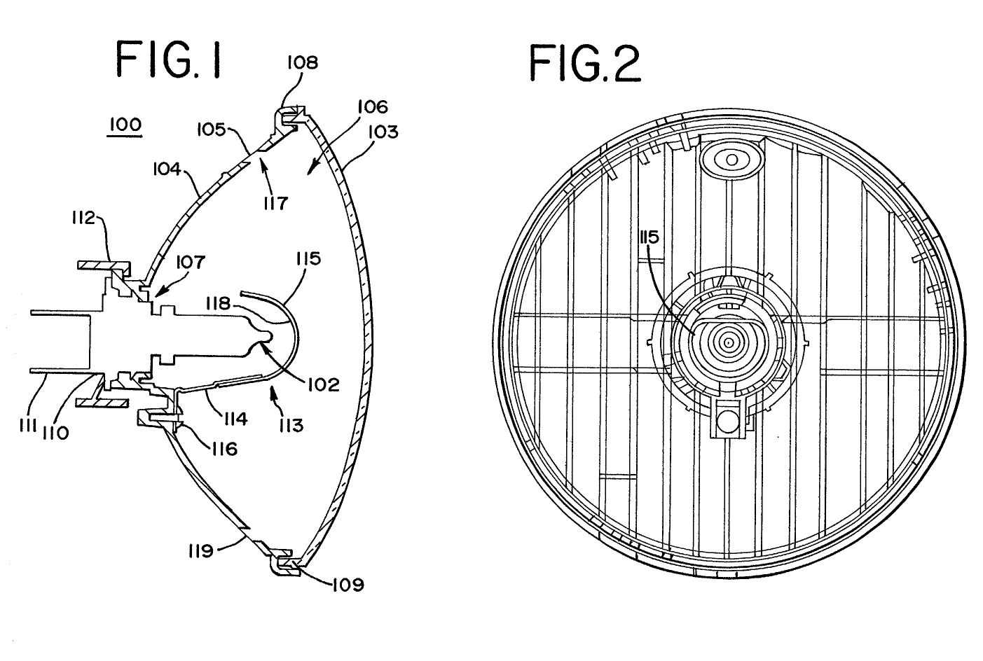

Referring to FIG. 1, also located on the inner surface of the reflector 104 is a shield assembly 113. The shield assembly 113 includes a shield 114 having one end portion 115 formed in the shape of a hemisphere. The base end 116 of the shield 114 is connected to the inner surface of the reflector 104 near the rear opening 107. A 3×9.5″ pan head screw may be used to connect the shield assembly 113 to the inner surface of the reflector 104. The shield 114 partially surrounds the light source 102 and performs three distinct functions. First, the hemispherical portion 115 of shield 114 hides the light source 102 thereby increasing the headlamp's 100 aesthetic value, as generally shown in FIG. 2. The second function of the headlamp 100 is for optical purposes.

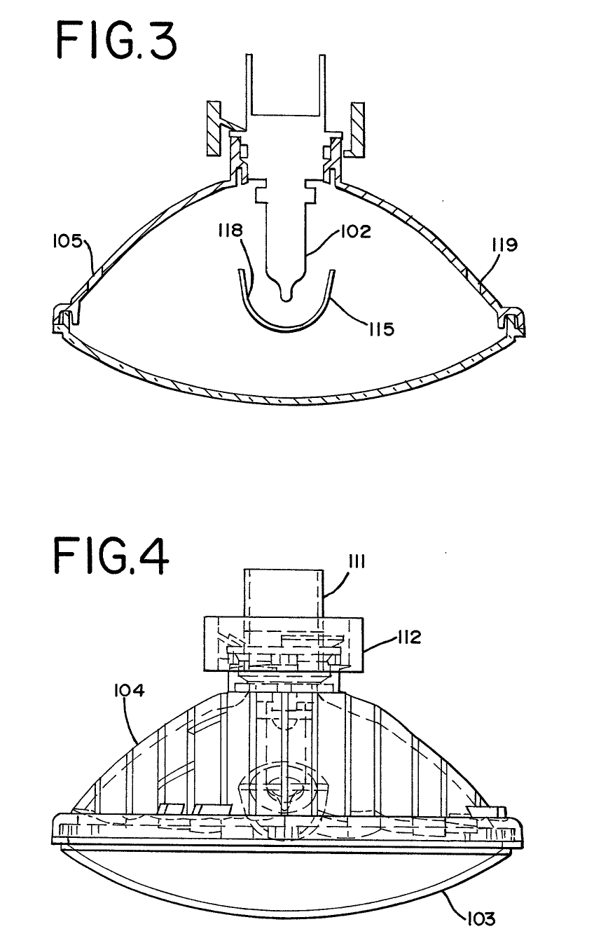

Referring to FIG. 3, the rearmost edge 118 of the hemispherical portion 115 is trimmed so that the light from the light source 102 will not impinge on non-optical surfaces and produce uncontrolled light. The third function of the shield 114 is that the hemispherical portion 115 acts as a heat shield.

Referring now to FIGS. 1 and 3, in use, the light source 102 may become very hot and the hemispherical portion 115 of the shield 114 will help to absorb and dissipate the heat that would otherwise affect the upper surface of the headlamp 100 or lens 103. Additionally, there is black coating applied to the inside portion of the hemispherical portion 115 that can significantly reduce reflections inside the shield 114 that might incident the reflector 104 to reflect to unwanted areas. If the shield 114 is not present all three functions will be adversely affected.

The inner surface of the reflector 104 is coated with a thin film of highly reflective aluminum. It is applied by a process called vacuum metallization. Additionally, a thin coat of a polymer is applied to the surface of the aluminum to prevent oxidation of the surface. This coating is applied just after the metallization process. The reflector 104 is molded from a thermoset plastic material. The reflector 104 is prepared for the aluminum by a base coating of the inner surface to make it very smooth. This coating is applied then cured by using a strong UV light. The reflector 104 must also be protected from moisture to further prevent corrosion of the reflector 104.

Protection from moisture is accomplished by providing a valve assembly 117 disposed on the reflector 104. The valve assembly 117 is comprised of the vent 105 that allows airflow into the interior of headlamp 100 but prevents moisture from entering into the interior of headlamp 100. The vent 105 is made of Gore-tex® by W. L. Gore & Associates, Inc., Newark, Del. Gore-tex® is a micro-porous material commonly used for wet weather outer clothing, such as, jackets, boots and the like. The vent 105 also equalizes the pressure in the headlamp 100 with the outside and reduces the internal stresses in the headlamp 100.

In a preferred embodiment, a vent 105 is located at the top of the headlamp 100 where the heat of the light source 102 will act to promote the greatest convective flow of hot air. The heat will also act to dry the micro-porous material out very quickly if it is wet. A second vent 119 maybe located toward the bottom of the headlamp 100 that will allow the vents 105, 119 to let air into and out of the headlamp 100. As previously stated, the vents 105, 119 will prevent moisture from entering the interior of headlamp 100 and provide pressure equalization between outside of headlamp 100 and the inside of headlamp 100. As the headlamp 100 heats up with the light source 102 energized, the air within the headlamp 100 expands and creates pressure. Because the light source 102 gets very hot, the pressure inside the headlamp 100 may be significant. The vents 105, 119 allow the pressure within the headlamp 100 to be relieved to the outside and eventually the pressure is equalized and so stress is relieved. This headlamp 100 is structured to be an exact replacement for the 7″ round sealed beam headlamp except with a replaceable light source 102 and uses the exact same hardware for installation.

The foregoing detailed description is merely illustrative of several physical embodiments of the invention. Physical variations of the invention, not fully described in the specification, may be encompassed within the purview of the claims. Accordingly, any narrower description of the elements in the specification should be used for general guidance, rather than to unduly restrict any broader descriptions of the elements in the following claims.

I claim:

1. A headlamp apparatus, comprising:
a cup-shaped reflector comprising a front opening, a rear opening and a valve assembly disposed thereon for allowing air external to said headlamp apparatus to flow into an interior of said headlamp while moisture is prevented from entering into said interior of said headlamp apparatus;
a lens secured to said front opening for closing said front opening and defining said interior and exterior of said headlamp apparatus; and
a socket retention assembly containing a light source disposed within said rear opening.

2. The headlamp apparatus of claim 1, wherein said valve assembly comprises a micro-porous vent.

3. The headlamp apparatus of claim 1 wherein said valve assembly provides pressure equalization between said exterior of said headlamp apparatus and said interior of said headlamp apparatus.

4. The headlamp apparatus of claim 1 further comprising an adhesive between said front opening and said lens for holding and sealing said lens to said front opening.

5. The headlamp apparatus of claim 1 further comprising an annular retainer ring for holding and sealing said socket retention assembly within said r ear opening.

6. The headlamp apparatus of claim 1, further comprising an O-ring for holding and sealing said light source within said socket retention assembly.

7. The headlamp apparatus of claim 1, wherein said light source is removable.

8. The headlamp apparatus of claim 1, wherein said socket retention assembly further comprises a terminal located rearward on said socket retention assembly, said terminal extending exteriorly of said socket retention assembly.

9. The headlamp apparatus of claim 8, wherein said light source comprises a bulb and connecting portions for electrically connecting said light source to said terminal when said light source is disposed within said socket retention assembly.

10. The headlamp apparatus of claim 1 further comprising a shield assembly disposed on said interior of said cup-shaped reflector.

11. The headlamp apparatus of claim 10, wherein said shield assembly comprises a shield having a first end formed in a hemispherical shape and a second end;
wherein said second end of said shield is connected to said interior of said cup-shaped reflector such that said first end of said shield surrounds said light source.

12. The headlamp apparatus of claim 1, wherein said headlamp is water resistant.

13. The headlamp apparatus of claim 1, wherein said headlamp is structured to replace a 7″ round sealed beam headlamp.

14. A method for operating a headlamp apparatus, comprising:
turning on a light source within said headlamp apparatus;
allowing air to flow within an interior of said headlamp apparatus; and
preventing moisture from entering said interior of said headlamp apparatus.
